(19) United States
(12) Patent Application Publication
(10) Pub. No.: US 2010/0077260 A1
(43) Pub. Date: Mar. 25, 2010

(54) TESTING MACHINE WITH WORKFLOW BASED TEST PROCEDURE

(75) Inventors: Sree Pillai, Burnsville, MN (US); Darragh E. Murphy, Chaska, MN (US); Thomas K. Talmo, Excelsior, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: MTS Systems Corporation, Eden Prairie, MN (US)

(21) Appl. No.: 12/564,593

(22) Filed: Sep. 22, 2009

Related U.S. Application Data
(60) Provisional application No. 61/099,161, filed on Sep. 22, 2008.

(51) Int. Cl. G06F 11/28

(52) U.S. Cl. 714/46; 714/E11.178

(57) ABSTRACT

A test machine system and a method for operating a test machine system includes using a readily available workflow program to a test procedure created using a graphical user interface to arrange test procedure elements.

### CROSS-REFERENCE TO RELATED APPLICATION

This application claims the benefit of U.S. Provisional Application entitled “System and Method for Creating Test Procedure for Testing Machine” having Ser. No. 61/099,161, and filed Sep. 22, 2008, the content of which is incorporated herein by reference in its entirety.

### BACKGROUND

The discussion below is merely provided for general background information and is not intended to be used as an aid in determining the scope of the claimed subject matter.

There are numerous types of machines performing testing, such as testing of materials or devices. Such testing machines can be configured to perform relatively complex testing procedures that involve numerous processing steps. The process flow can be complicated, with conditional branching, parallel procedures, loop back, and many more different configurations of the process flow.

In the current testing paradigm, tests (in actual hardware or during simulation) are created predominantly using sequential, event driven, or data flow driven methods. Sequential methods can be limiting while event driven and data flow driven methods can become overly complex.

Furthermore, changing the test sequence is limited in sequential methods and laborious in event driven or data flow driven methods.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

Generally, there is a need for methods and systems that provide for easing the creation of hardware test procedures for test flow designers.

This and other needs are met by presently disclosed embodiments that provide a system for creating a test flow for a hardware or simulation test, comprising a graphical user interface (GUI) and a processor coupled to the GUI and configured to cause the GUI to graphically display test activities, and to couple the test activities on the GUI into a displayed test flow, with the test activities being correspondingly coupled by the processor into the test flow to be carried out in the hardware or simulation test.

The presently disclosed embodiments use workflow program technology, such as embodied in Microsoft Workflow Foundation, a commercially available product as one example, within a test environment. The test activities are provided to a test flow engineer as a graphical toolset. The test activities can be dragged and dropped on the surface of the GUI. Once on this design surface, the test activities represented by the icons can be controlled, manipulated and sequenced in any desirable manner.

As some general aspects of the present invention, a test machine system and a method for operating a test machine system includes using a readily available workflow program to represent a test procedure created using a graphical interface to arrange test procedure elements.

In one embodiment, a testing machine system is configured to apply tests to a test specimen and obtain measurement therefrom. The testing machine includes at least one computer having a graphical user interface. A test procedure generator is configured to operate on said at least one computer. The test procedure generator includes a workflow program configured to receive user input using the graphical user interface and create a test procedure represented by connected graphical icons. The test procedure generator is configured to output a textual output readable by a human representing the test procedure. The test machine includes a controllable element configured to apply a test to a test specimen. The system controller is configured to operate on said at least one computer and receive the data related to the textual output and control the controllable element as defined by the test procedure.

In another embodiment, a testing machine system is configured to apply tests to a test specimen and obtain measurement therefrom. The testing machine includes at least one computer having a graphical user interface. A test procedure generator is configured to operate on said at least one computer. The test procedure generator includes a workflow program configured to receive user input using the graphical user interface and create a test procedure represented by connected graphical icons. The test procedure generator is configured to output a textual output readable by a human representing the test procedure. A test machine comprising an actuator assembly is configured to apply a load to or displace the test specimen. An execution engine module is configured to operate on said at least one computer, the execution engine configured to receive the textual output and provide a command for use as a basis to control the actuator assembly as defined by the test procedure.

As yet another aspect, a computer implemented method for controlling a test machine pursuant to a test procedure is provided. The test machine includes a plurality of modules, wherein each of the modules correspond to an element of the test procedure. The method includes operating a workflow program on a computer with a graphical user interface to configure a test procedure using connected graphical icons representative of elements of the test procedure; operating the workflow program to generate a textual output data in a form readable by a human representing the test procedure; and accessing the textual output data to initiate a selected module of the plurality of modules based on a portion of the textual output, the module configured to control a controllable element operably coupled to a test specimen.

In yet a further aspect, a testing machine system is configured to apply tests to a test specimen and obtain measurement therefrom. The testing machine system includes at least one computer. The computer has a graphical user interface. A test machine has a controllable element configured to apply a test to a test specimen. A test procedure generator is configured to operate on said at least one computer. The test procedure generator includes a workflow program configured to receive user input using the graphical user interface and create a test procedure represented by connected graphical icons representing corresponding activities for controlling the controllable element.

In yet another aspect, a computer implemented method for controlling a test machine pursuant to a test procedure is provided. The method includes operating a workflow program on a computer with a graphical user interface to configure a test procedure using connected graphical icons representative of activities of the test procedure; and obtaining an output from the workflow program and using the output to control the test machine pursuant to the arranged graphical icons.

### BRIEF DESCRIPTION OF THE DRAWINGS

FIG. 1 is a block diagram of an schematic test machine.

FIG. 2 is a block diagram depicting certain components of a system for creating a test flow procedure for a testing machine according to certain disclosed embodiments.

FIGS. 3-10 illustrate exemplary screen shots from a graphical user interface (GUI) during the creation of a test flow, employing presently disclosed embodiments.

FIGS. 11-12 illustrate block diagrams of exemplary workflow scenarios.

FIG. 13 illustrates block diagrams a test procedure generator, system controller and servo controller.

### DETAILED DESCRIPTION

The creation of a test flow procedure for use with a testing machine has previously been cumbersome, making adjustments to the test flow procedure difficult and time-consuming. This has limited the ability for users of the test machine to modify the tests performed by the machines, without the assistance of a skilled test developer. The embodiments of the present disclosure address and solve these concerns, at least in part, by providing a system for creating a test flow for a hardware or simulation test, comprising a graphical user interface (GUI) and a processor coupled to the GUI and configured to cause the GUI to graphically display test activities, and to couple the test activities on the GUI into a displayed test flow, with the test activities being correspondingly coupled by the processor into the test flow to be carried out in the hardware or simulation test.

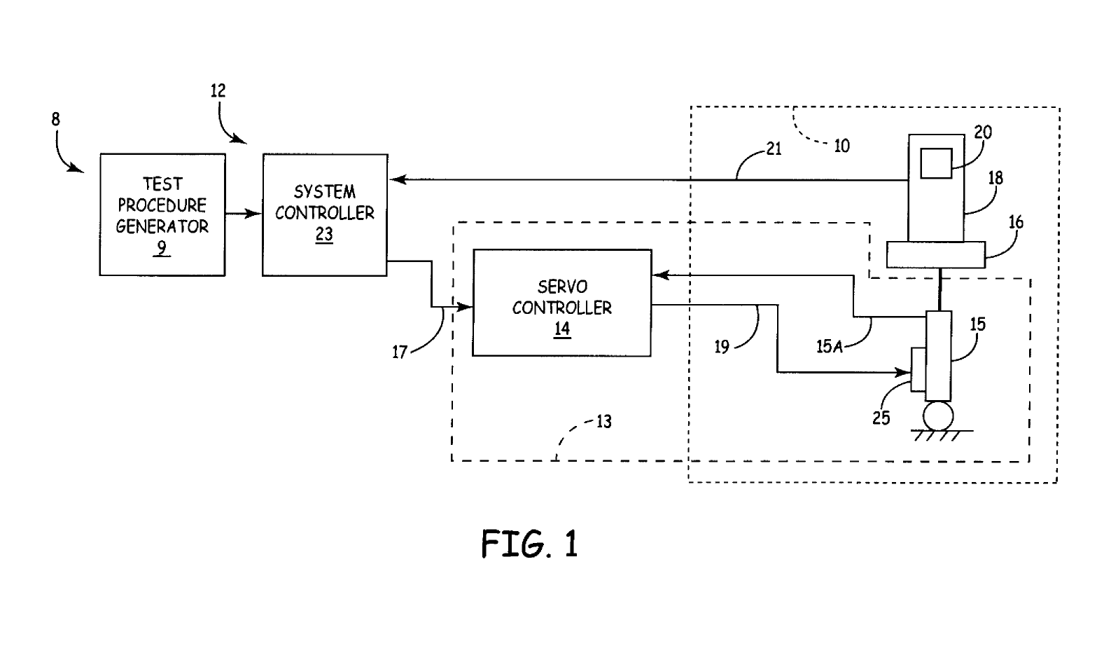

FIG. 1 illustrates a testing machine system 8 comprising a test procedure generator 9 for generating a test procedure that is used to control a test machine 12. Test machine 12 includes a plant or physical system 10. In the exemplary embodiment, the physical system 10 generally includes a controllable element such as an actuator system, motor or the like. Herein an actuator system 13 comprising a servo controller 14 and an actuator 15 (hydraulic, pneumatic and/or electric). In the schematic illustration of FIG. 1, the actuator 15 represents one or more actuators that are coupled through a suitable mechanical interface 16 to a test specimen 18. The servo controller 14 provides an actuator command signal 19 to a servo valve 25 to operate the actuator 15, which in turn, excites the test specimen 18. It should be noted the servo controller 14 is of a design suitable for controlling the type of actuator employed. Suitable feedback 15A can be provided from the actuator 15 to the servo controller 14 or from other sensors. One or more remote transducers 20 on the test specimen 18, such as displacement sensors, strain gauges, accelerometers, or the like, provide a measured or actual response 21. A system controller 23 receives an actual response 21 as feedback in a response to a drive 17 as input to the servo controller 14. In the illustration of FIG. 1, signal 17 is a reference signal, signal 19 is a manipulated variable (command to actuated device) and signal 15A is a feedback variable. Although illustrated in FIG. 1 for the single channel case, multiple channel embodiments with signal 15A comprising N feedback components and the signal 19 comprising M manipulated variable components are typical and considered another embodiment of the present invention. The test specimen 18 can take any number of forms such as but not limited to material samples, substructures or components. Typically, types of loads that can be applied or imparted to the test specimen 18 include tension, compression and/or torsion in one or more degrees of freedom applied separately or at the same time. The test specimen 18 can also or alternatively be subjected to controlled displacements in one or more degrees of freedom applied separately or at the same time.

Although illustrated with actuator system 13, this should not be considered limiting. The test machine 12 can be any of a number of different machines, as the presently disclosed embodiments allow creation of test flows for different types of test machines. These can include machines for testing materials, durability, operability of devices, measuring characteristics, etc. The universal nature of the test flow creation process according to the presently disclosed embodiments provides applicability and ease of test flow creation or modification for any number of different test machines.

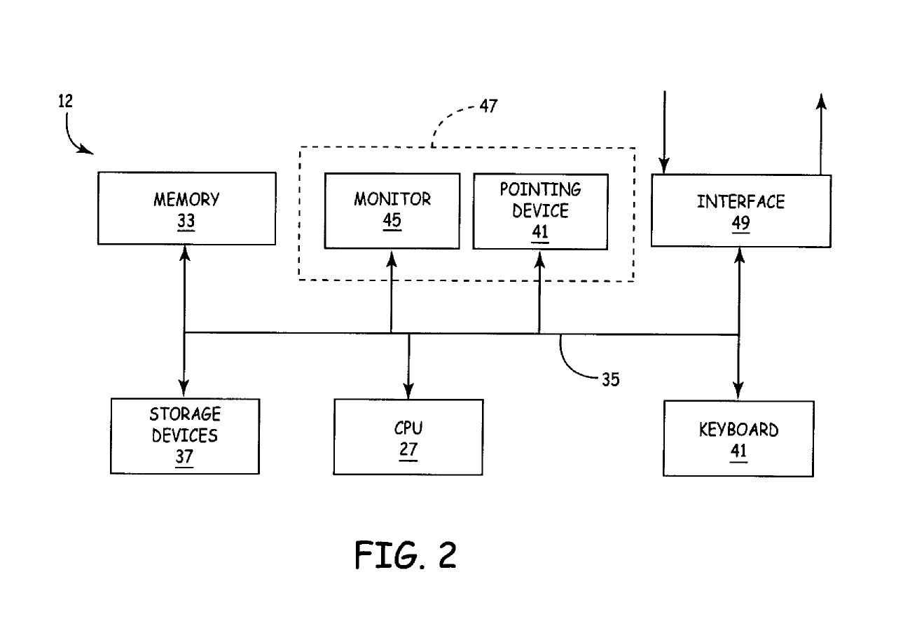

The test procedure generator 9, servo controller 14 and system controller 23 can each be implemented on a digital and/or analog computer. FIG. 2 and the related discussion provide a brief, general description of a suitable computing environment in which the test procedure generator 9, servo controller 14 and system controller 23 may each be implemented. Although not required, the test procedure generator 9 and system controller 23 will be described, at least in part, in the general context of computer-executable instructions, such as program modules, being executed by a computer 19. Generally, program modules include routine programs, objects, components, data structures, etc., which perform particular tasks or implement particular abstract data types. The program modules are illustrated below using block diagrams. Those skilled in the art can implement the description below and block diagrams to computer-executable instructions storable on a computer readable medium. Moreover, those skilled in the art will appreciate that the invention may be practiced with other computer system configurations, including multi-processor systems, networked personal computers, mini computers, main frame computers, and the like. Aspects of the invention may also be practiced in distributed computing environments where tasks are performed by remote processing devices that are linked through a communications network. In a distributed computer environment, program modules may be located in both local and remote memory storage devices.

The computer 19 illustrated in FIG. 2 comprises a conventional computer having a central processing unit (CPU) 27, memory 33 and a system bus 35, which couples various system components, including memory 33 to the CPU 27. A system bus 35 may be any of several types of bus structures including a memory bus or a memory controller, a peripheral bus, and a local bus using any of a variety of bus architectures. The memory 33 includes read only memory (ROM) and random access memory (RAM). A basic input/output (BIOS) containing the basic routine that helps to transfer information between elements within the computer 19, such as during start-up, is stored in ROM. Storage devices 37, such as a hard disk, a floppy disk drive, an optical disk drive, etc., are coupled to the system bus 35 and are used for storage of programs and data. It should be appreciated by those skilled in the art that other types of computer readable media that are accessible by a computer, such as magnetic cassettes, flash memory cards, digital video disks, random access memories, read only memories, and the like, may also be used as storage devices. Commonly, programs are loaded into memory 33 from at least one of the storage devices 37 with or without accompanying data.

Input devices such as a keyboard 41 and pointing device (mouse) 43, or the like, allow the user to provide commands to the computer 19. A monitor 45 or other type of output device is further connected to the system bus 35 via a suitable interface and provides feedback to the user. If the monitor 45 is a touch screen, the pointing device 43 can be incorporated therewith. The monitor 45 and typically an input pointing device 43 such as mouse together with corresponding software drivers form a graphical user interface (GUI) 47 for computer 19 that is particularly useful with test procedure generator 9 as described below.

Interfaces 49 on each of the test procedure generator 9 and system controller 23 allow communication between the test procedure generator 9 and the system controller 23. Likewise, interfaces 49 on each of the system controller 23 and the servo controller 14 allow communication between the system controller 23 and the servo controller 14. Interface 49 also represents circuitry used to send signals 19 or receive signals 15 and 21 as described above. Commonly, such circuitry comprises digital-to-analog (D/A) and analog-to-digital (A/D) converters as is well known in the art. The servo controller 14 can also comprise an analog controller with or without digital supervision as is well known. Functions of test procedure generator 9, controller 23 and controller 14 can be combined into one computer system. In another computing environment, controller 14 is a single board computer operable on a network bus of another computer, which could be controller 23 or another supervisory computer. The schematic diagram of FIG. 2 is intended to generally represent these and other suitable computing environments.

The creation or modification of a test flow for a test machine (12) would typically require a skilled test developer due to the complexity or limitations of the current methods. This may cause the user to be constrained by the test procedures provided. When the test machine is delivered and operated by a customer, the customer is constrained by the test procedure already provided. Should it be desired to modify the test procedure for that test machine, an experienced programmer and test developer is needed to modify the lines of code in the software program that operates the test machine. Similar concerns arise in the context of providing an initial program for the test machine 12.

The embodiments employ a “workflow” type program as part of the system for creating a test procedure. The concept of workflow engines that create workflows is known. In one embodiment, Microsoft Workflow Foundation by Microsoft Corporation of Redmond, Wash. is employed within the test procedure creation system of the present disclosure although other workflow type programs can be used.

A workflow can be considered to be a flowchart of actions with a beginning, an end, and a sequential flow from start to finish herein specifically to control a controllable element of a test machine. Workflows can incorporate parallel branches that operate simultaneously or based on conditions or looping, but ultimately they progress from the initial action to the final action. The building blocks of a workflow comprise events, actions, conditions and steps. An event is what starts or initiates a workflow. An action is an activity that is performed within the workflow. Conditions interact with conditional logic, so that a rule may establish a condition where the associated action is performed only if that condition is true. There can be single or multiple conditions for a step in the workflow. The steps make up the workflow, and each step can contain any number of actions and associated conditions.

Each of the workflow elements, i.e., the events, actions, conditions and steps can be defined using the workflow type program using editing capabilities of the workflow program. The workflow program provides generic template(s) to which events, actions, conditions and steps can be defined with corresponding attributes and/or properties (fixed or variable) as necessary. A graphical icon is assigned to each as necessary allowing them to be dragged and dropped using the GUI interface to interconnect the graphical icons and render a flowchart (visual depiction) of activities being a representation of the test procedure.

Briefly, with respect to test machine 12, the elements which control test procedure flow include an “If Else Condition” activity, a “Parallel Path” activity or and a “While Loop” activity. Each of these control elements can include yet other events, actions, conditions and steps in a hierarchical nature. The “If Else Condition” creates two possible paths for a test procedure based on a conditional expression that evaluates to True or False. If the expression evaluates to True, the test procedure follows the “If” path. If the expression evaluates to False, the test procedure follows the “Else” path. The evaluated condition can be the result of a response from the operator, or it can be an evaluation of a specific test value or condition. The two possible paths for the procedure to follow are automatically created when the “If Else Condition” activity to the test procedure. Each path can contain zero or more activities.

The “Parallel Path” activity enables one to use alternate and parallel paths within a test procedure. Each parallel path can contain a series of activities that run sequentially within that path. The activities in the path run simultaneously and independently of activities in the other parallel paths. By default, the activity completes when all the activities in all parallel paths complete. Optionally one specify that the activity completes when one or more activities, selected from the list of all activities in all parallel paths, completes.

The “While Loop” activity repeatedly runs the activities defined within it as long as a defined condition evaluates to True. If the defined condition is False at the start or at the repeat of the loop, the While Loop activity does not run. The tested condition can be the result of a response from the operator or an evaluation of a specific value or condition.

By way of example, activities that can be used with a test machine 12 include the following.

“Dwell” activity commands the control signal to hold a level for a specified duration of time.

“Ramp” activity commands the control signal from its current end-level state to a specified end level within a specified amount of time.

“Cycle” activity commands the control signal to cycle between two different end levels at a specified frequency, using a specified wave shape, for a specified number of cycles. Two end levels form one cycle. The number of cycles determines the required number of end levels. The frequency determines the speed required to achieve the end levels.

“Custom Waveform” activity commands a control channel using a series of ramp and hold segments to make up a custom trapezoid waveform. Each ramp can have a different duration and end level, and each hold can have a different duration. The shape of the ramp segment is linear. The number of cycles determines how many times the entire custom waveform is generated.

“Data Acquisition” activity accumulates data for selected signals. The activity requires at least one trigger and one signal. The trigger defines the method for acquiring data points (e.g. timed acquisition a selected sample rate, when the value changes by a selected amount, etc). The total number of data points to acquire can be prescribed. The Data Acquisition activity usually is in parallel with the foregoing Dwell, Ramp, Cycle and Custom Waveform.

Besides acquiring data is indicated above, events can be detected. Some useful events include when a calculated variable changes by more than a specified amount in a cycle, or when a comparison between two values is consistent within a defined percentage for a defined number of cycles, a stable cycle is detected. Likewise, upper or lower limits can be detected in a signal. Particular program states can be also be detected or when a change of state occurs. It should be noted that the activities, events or other forms of test procedure elements described herein can pertain to many different types of test machines including test machines having actuator assemblies, which are particularly useful for applying loads (forces and/or torques) to or control displacement of the test specimen. These activities, events, etc. described herein merely illustrate some of the test procedure elements that can be created and used. Those skilled in the art can generate these activities and other activities using the workflow program described above for any form of testing wherein the test procedure elements herein described should not be considered limiting. The appendix provides more information on data acquisition, the above-described activities and other activities useful in generating test procedure in a workflow environment. Each activity, as appropriate, would include a graphical icon to visually represent the activity. The properties of each are either set or allowed to be specified.

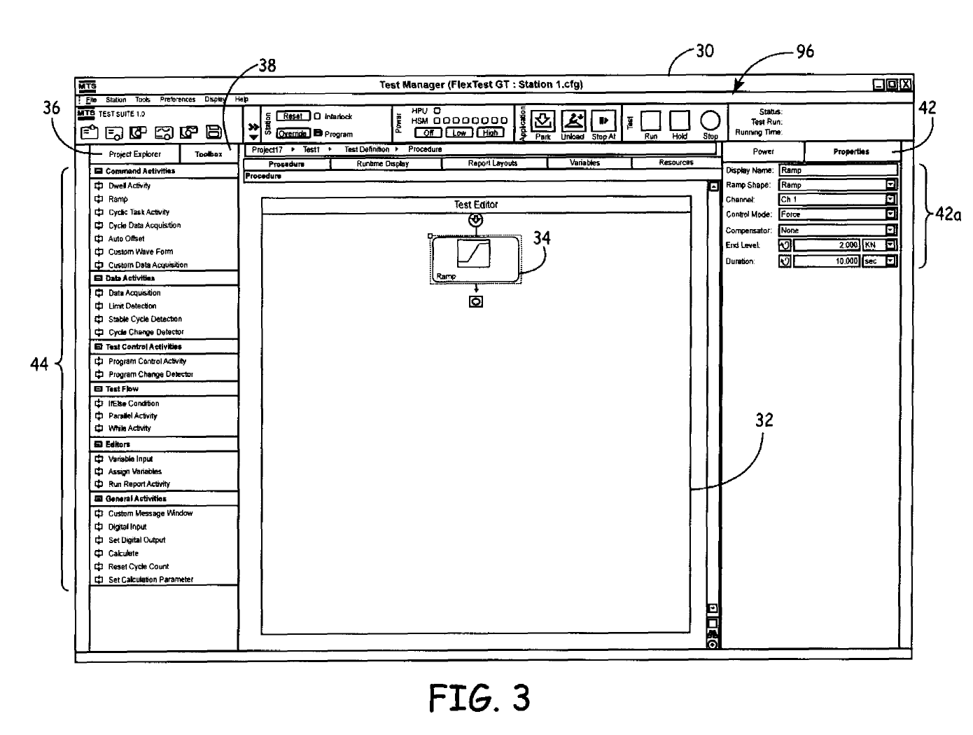

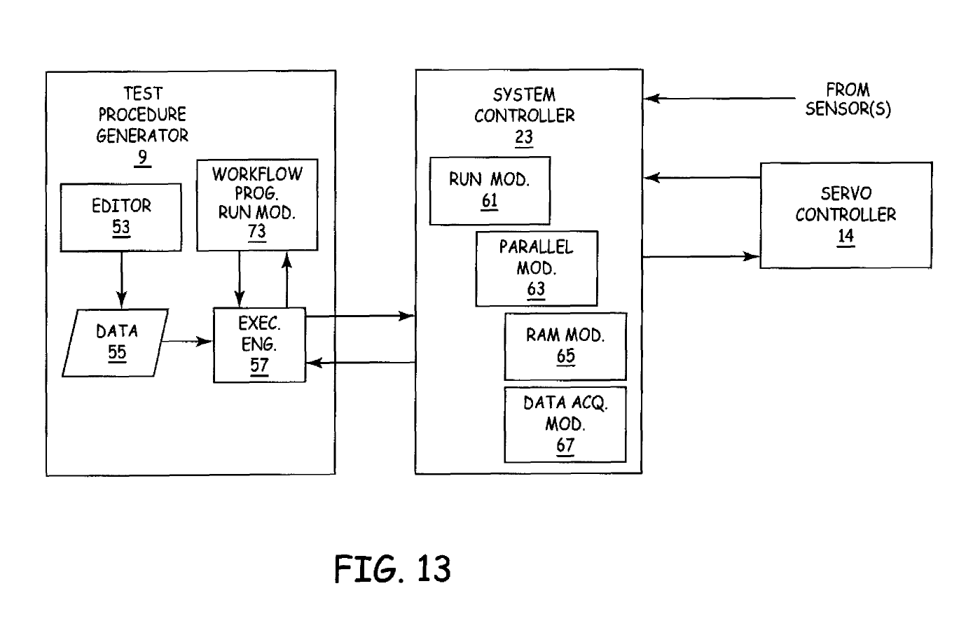

FIGS. 3-10 are exemplary screenshots of elements of a graphical toolset that allow a test procedure to be created or modified using a (FIG. 13). The workflow in these screenshots are exemplary only, and merely provide an example of the creation of a test procedure using some of the elements described. The test procedure editor module 53 for creating the test procedure can be located in memory 33 or storage devices 37 and accessible by processor 27.

FIG. 3 depicts a screenshot of the GUI 47 during creation of an exemplary test procedure. The test procedure editor module 53 provides a screen 30 that has a test editor window 32, which graphically depicts test activities as they are placed into the procedure flow. For example, FIG. 3 shows application of a ramp signal as a test activity 34 that has been added to the procedure within the test editor window 32. This test activity can be provided on the test editor window 32 by a conventional GUI technique, such as dragging and dropping the icon for the ramp signal test activity, or selecting the ramp signal from a menu of test activities. In other words, the test activities are responsive to navigational indicators, such as mousing and other manipulation techniques.

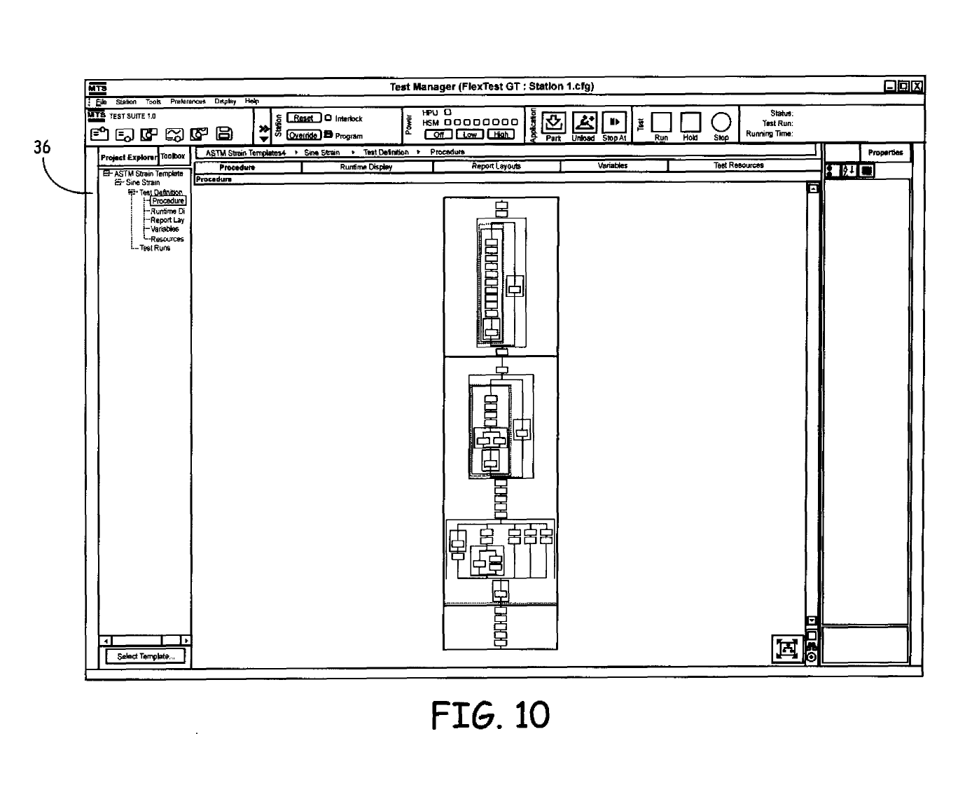

The test procedure editor module 53 provides other buttons and windows discussed below. For example, button 36 is a project explorer button, which when activated, displays different test procedures or portions thereof that have already been created and may be opened, as best seen in FIG. 10. This area may also provide a pre-set template for particular types of tests, from which a user can select such a template to then create and customize a test procedure.

Referring back to FIG. 3, a toolbox button 38 provides the graphical toolbox 44 employed by a test creator or a user to create or modify a test procedure in a graphical manner. In the illustrated embodiment, the graphical toolbox 44 includes a menu from which command activities, data activities, test control activities, test flow, editors and general activities can be selected. The various activities and other features of the graphical toolbox 44 can be selected by pointing and clicking or other input methodology.

A properties button 42 is provided, which provides a list of properties of the currently selected activity. In certain embodiments, the user can select or modify the properties of the selected activity through one of the boxes 42A. In this case, the display name box lists “Ramp”, and the Ramp Shape is “Ramp”, etc.

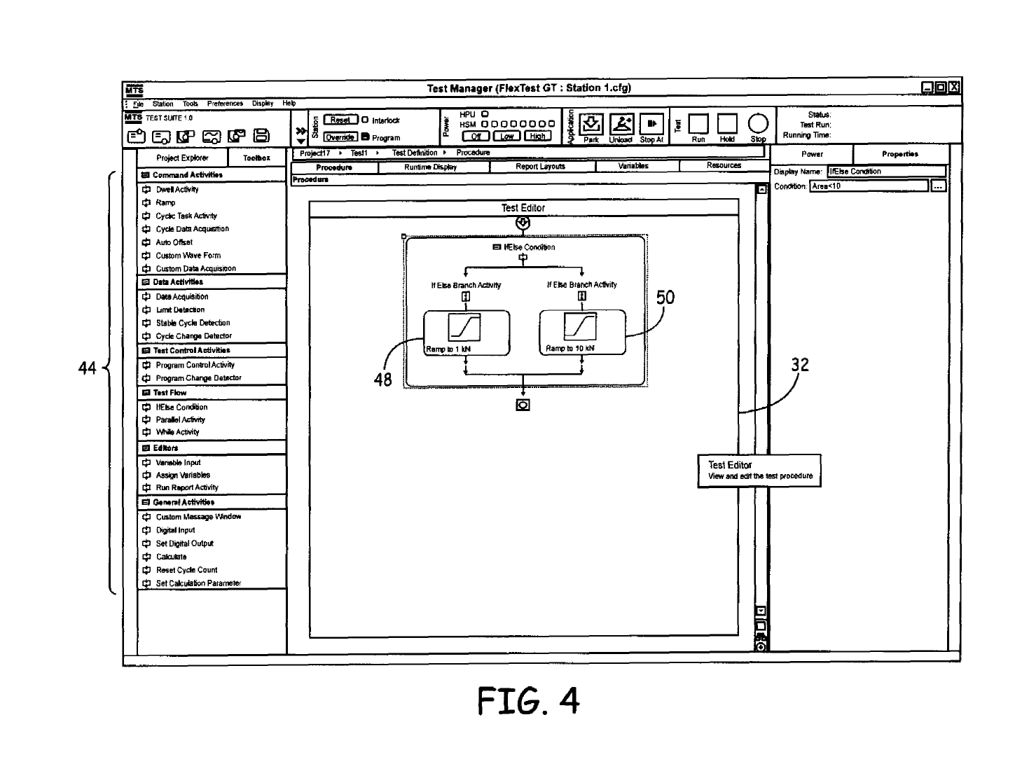

FIG. 4 depicts the selection of an “If Else Condition” activity 46 from the Test Flow portion of the graphical toolbox 44. When the “If Else Condition” 46 is initially dragged and positioned in the text editor window 36, it is unfilled in each of the branches. After it has been placed in the text editor window 32, then each of the branches can be filled with desired activities, events, conditions and/or steps. In this sample example, one of two different ramp activities 48, 50 can be performed, depending on the condition. Based on a logical check on specimen size, a ramp to either 1 kN (test activity 48) or a ramp to 10 kN (test activity 50) is executed.

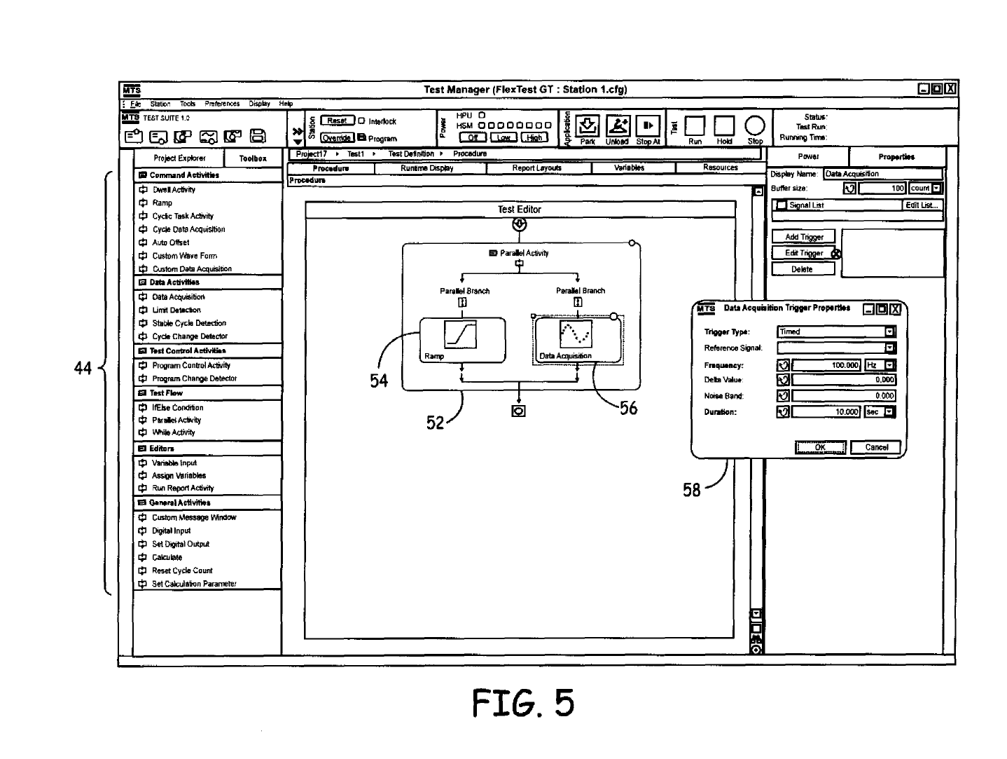

A “Parallel Path” activity 52 is depicted in FIG. 5. This may be selected from the Test Flow portion of the graphical toolbox 44. When the “Parallel Path” activity 52 is initially dragged and positioned in the text editor window 36, it is unfilled in each of the branches. After it has been placed in the text editor window 32, then each of the branches can be filled with desired activities, events, conditions and/or steps. As its name implies, this Test Flow selection activity causes two sets of activities, events, conditions and/or steps to occur in parallel. In the illustrated simple example, only data acquisition activity 56 is being performed while a ramp activity 54 is being executed. A data acquisition trigger properties box 58 may be provided, as shown in FIG. 5, to allow entry of certain properties of the Data Acquisition Trigger.

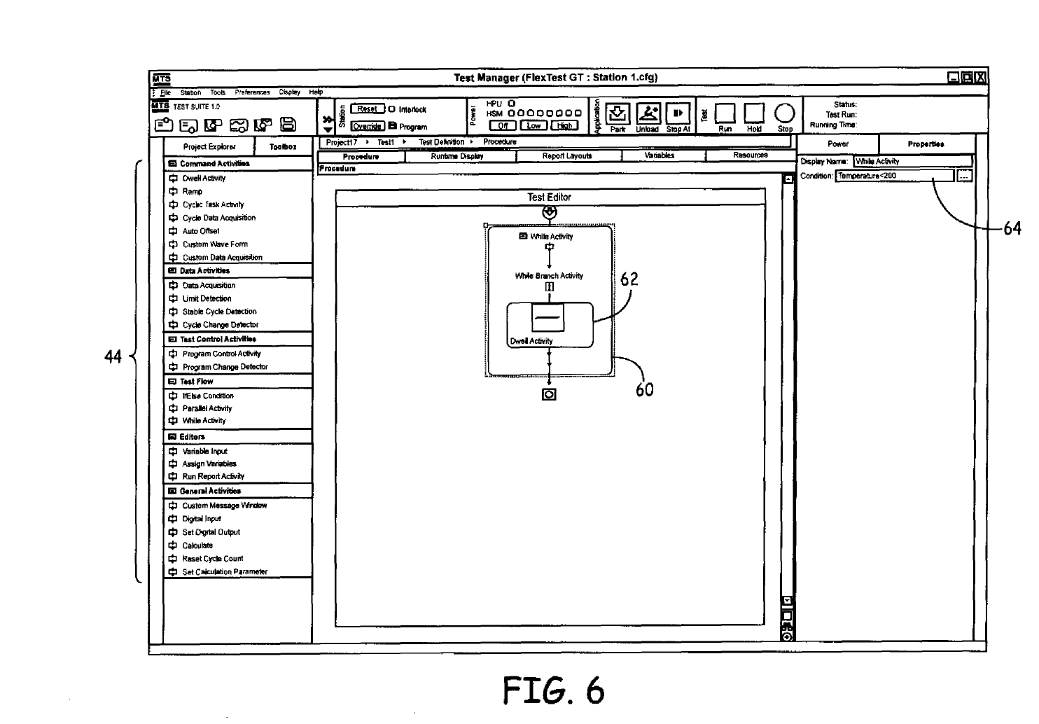

FIG. 6 depicts a screenshot showing a “While Loop” activity selected 60 from the Test Flow portion of the graphical toolbox 44. When the “While Loop” activity 60 is initially dragged and positioned in the text editor window 36, it is unfilled. After it has been placed in the text editor window 32, then each of the branches can be filled with desired activities, events, conditions and/or steps. Selecting “While Loop” activity will cause an activity or a set of activities, events, conditions and/or steps to be performed, such as dwell activity 62 in FIG. 6, to be executed while a condition is being met. The condition is depicted in box 64, as temperature <200. Hence, in this case, while the temperature is less than 200 C, the command is held steady at the previous load level.

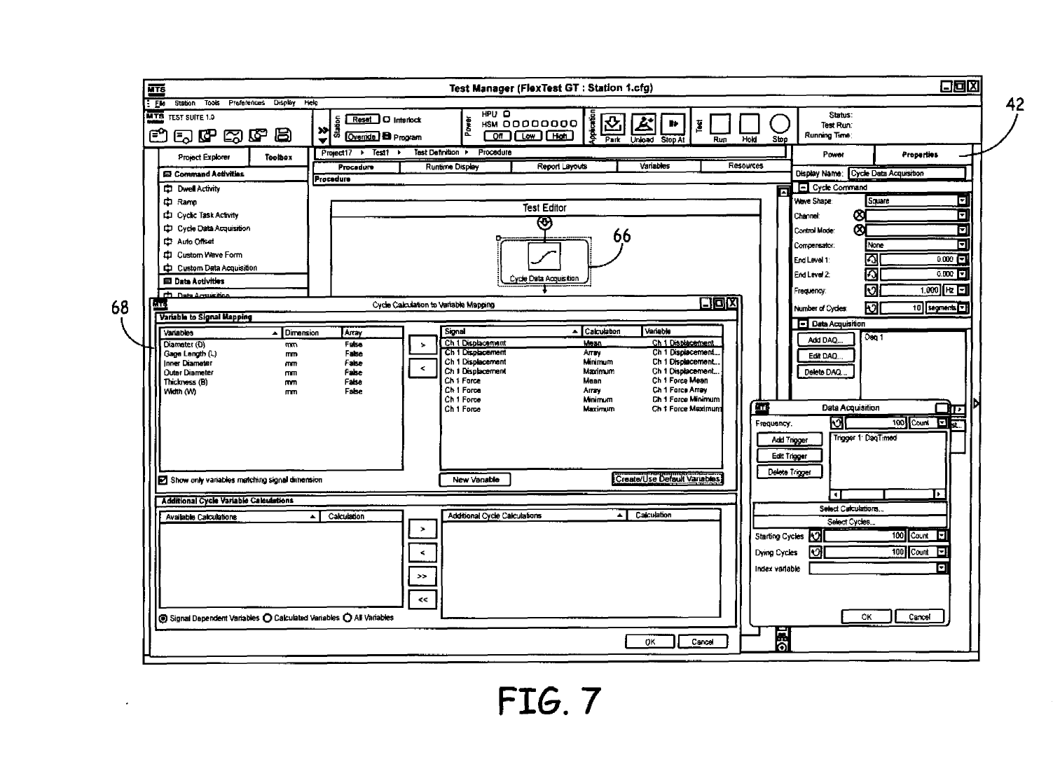

FIG. 7 depicts a combined command and data acquisition activity. In such a case, an activity, such as a cycle data acquisition activity 66, will play out a command and acquire data simultaneously as indicated above, and can also be configured to calculate variables defined by the user and derived from the acquired data. In FIG. 7, a cycle calculation to variable mapping window 68 is shown, which provides variable to signal mapping and additional cycle variable calculations. The properties of the cycle command and the data acquisition are provided through the properties section after selecting the properties button 42.

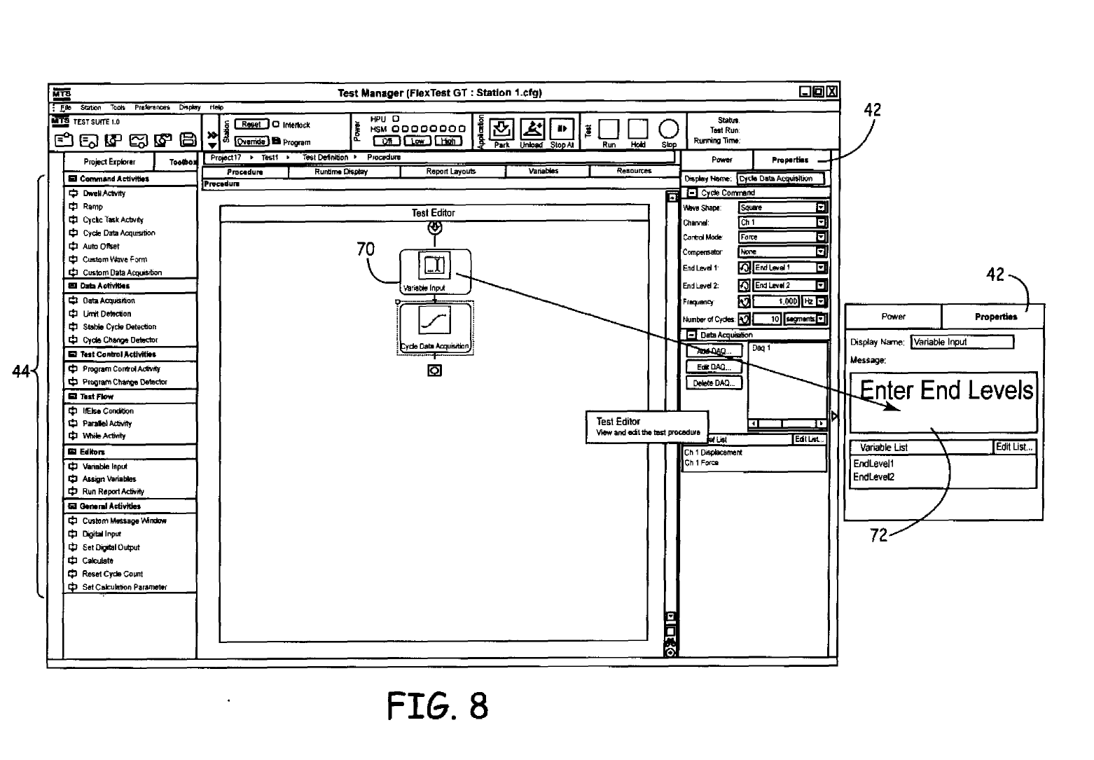

In FIG. 8, a Variable Input 70 is shown as selected from the Editors section of the graphics toolbox 44. With the Variable Input 70, command activity definition parameters can be made to depend on user entry or process calculated variables. The properties button 42 can be selected, which may bring up a message 72 to enter end levels, a detail of which is shown in FIG. 8.

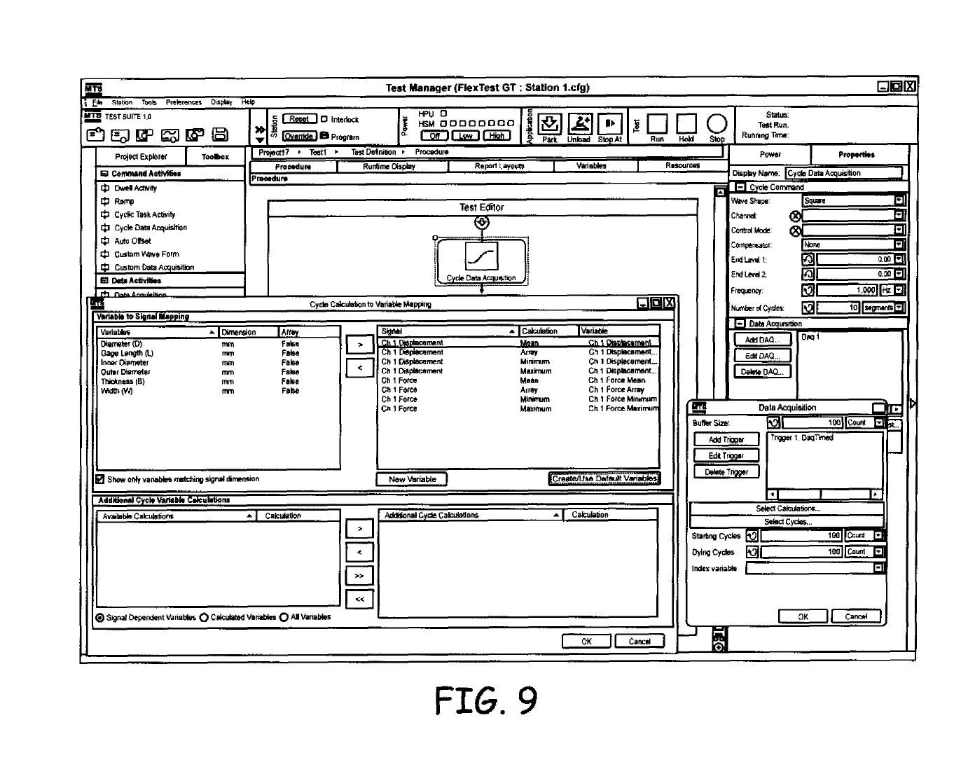

FIG. 9 depicts a screenshot of a scenario with combined command and data acquisition activity. In this case, an activity plays out a command and acquires data simultaneously, and can also calculate variables derived from the acquired data.

FIG. 10 shows a completed test flow, or test procedure. As can be appreciated from this figure, a complex user and calculation dependent procedure can be created for performing ASTM industry standards tests, employing the tools described above.

A discrete test procedure will have a beginning and an end. For example, in a low cycle failure test, a cyclic load will be applied to a specimen until the specimen breaks (i.e., fails). A test procedure for this test will comprise a set of logical atomic test activities and a set of conditions that determine the order of the test activities. A test activity may involve one or more resources. A resource can be a test operator or a hardware unit. A set of user-defined and system-defined variables control the conditions that affect the execution order within the test procedure.

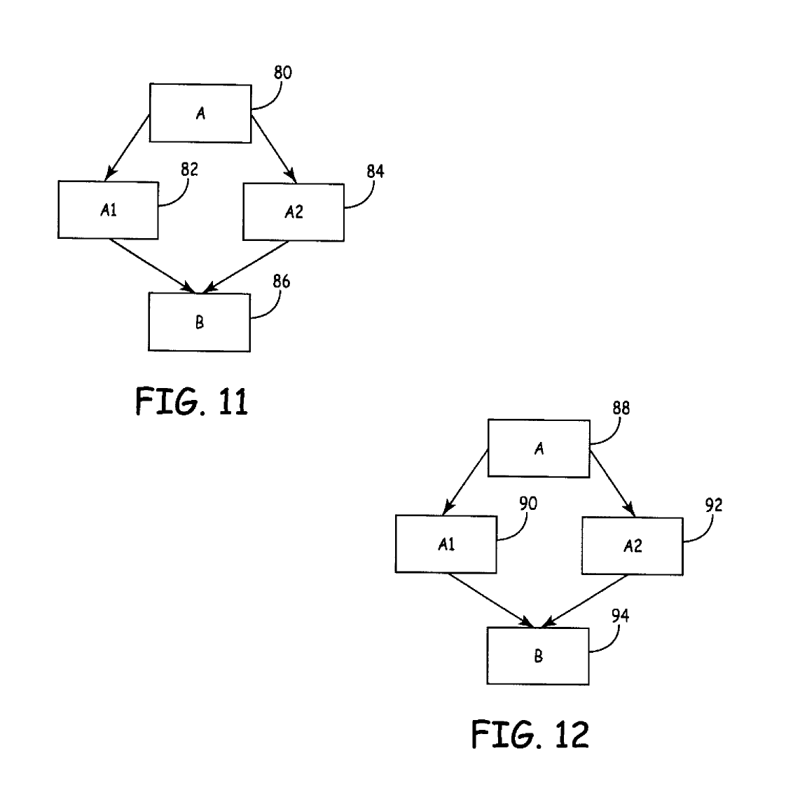

FIGS. 11 and 12 describe some workflow scenarios. In particular, FIG. 11 shows a scenario with parallel activity, the “And Join”. In this activity there is a convergence of two or more branches of activities into a single subsequent branch. All the child branch activities must be completed before proceeding to the next branch. Hence, in the example of FIG. 11, test activity 80, selected from among the available test activities, initiates “child” test activities 82, 84. The child test activities 82, 84 share the system resources and run independently of each other. However, the test activity 86 will execute only when both child test activities 82, 84 complete. Such a workflow scenario may occur when running a command activity and data acquisition activity in parallel.

FIG. 12 shows an example of a canceling discriminator scenario, in which there is a convergence of two or more branches of activities into a single, subsequent branch. The activity execution sequence includes test activity 88 initiating child activities 90, 92. In the case where test activity 90 completes first, test activity 94 starts execution and test activity 92 is cancelled. In the case where test activity 92 completes first, test activity 94 starts execution and test activity 90 is cancelled. The user specifies the discriminator activity during the design phase of the test procedure. In these cases, the discriminator can be either test activity 90 or test activity 92. This scenario finds applicability in running a command activity, data acquisition activity, and a limit detection activity in parallel. If a limit trips or the command stops naturally, the execution of the parallel branch should be stopped.

The Program Control Activity can be used to stop a test. On execution, this activity can be programmed to switch off the power, stop the test and log an entry in the user log. This test activity finds applicability in the scenario that if a limit exceeds a user-configured value, Program Control activity is configured to switch the power off the station.

When the test procedure is created, it can be readily edited in a graphical manner by simply moving the test activities icons on the test editor window. The parameters associated with the individual test activities can be readily changed through the use of the screen editor and corresponding screens/window earlier described to define associated properties or parameters. The system therefore provides an easy to use, intuitive tool that allows for creation and ready modification of a test procedure for a testing machine.

Following the creation of a test procedure, the test procedure generator 9 is used to cause the test machine 12 to perform the test according to the created test procedure. A number of operating buttons 96 are provided on the GUI (see FIG. 3, for example) that provide for management of a test procedure, including buttons for Run, Hold, Stop.

Referring to FIG. 13, in general, the test procedure editor module 53 generates test procedure data 55 such as a file, database, etc. that is stored in memory 33 and/or storage devices 37 that includes information representative of each of the activities, conditions, events and/or steps present in the test procedure and developed by the user using the test procedure editor module 53. Using a “workflow” type program such as described above, the test procedure data is not in a machine form or language that can directly execute the system controller 23 since such programs are commonly used to create pictorial workflows representative of a process (for example, the workflow in a construction project) typically rendered on a monitor, printer, or the data is outputted in spreadsheets to calculate hours, materials, etc. required. One aspect of the present invention is using such a program to generate a test procedure and taking the output (test procedure data 55) in a form provided by such programs and interpreting the data to control a test machine. 12. Since such programs are readily available, custom editors designed specifically for developing test procedures and executing such test procedures need not be designed.

One useful form of the test procedure that the test procedure editor module 53 will provide is in the form of text (using alphanumeric characters with or without other symbols such as ASCII (American Standard Code for Information Interchange) characters) readable by a human. The text can include recognizable words and/or acronyms, which can be embedded with other alphanumeric characters with or without symbols, indicative of the test procedure elements such as “parallel_{—}1”, “rampA”, “data_acq”, etc. In one embodiment, the test procedure data 55 is in the form of a markup language document, for instance, an XML document based on an XML schema and tags that define elements that can appear in a document, define attributes that can appear in a document, define which elements are child elements, define the order of child elements, define the number of child elements, defines data types for elements and attributes, defines default and fixed values for elements and attributes, to name just a few.

By way of a simple example to illustrate in general the form of the test procedure data 55, the test procedure data 55 for the FIG. 5 would include:

<Procedure>
<Parallel>

<Ramp>
...
</Ramp>
<Data_Acquisition>
...
</Data_Acquisiton>

</Parallel>
</Procedure>
where “...” pertain to attributes of each of the activites.

In the illustrated embodiment, the test procedure generator 9 also includes test procedure execution engine 57. When the “Run Test” button is activated, the test procedure execution engine 57 accesses the test procedure data 55, executes the test procedure that includes interpreting the test procedure data 55 and communicates with the system controller 23 to initiate task modules to perform each of the activities, conditions, events and steps in the test procedure data 55 applicable to operation of the test machine 12 pursuant to the attributes and/or parameters thereof. Although in one embodiment, the execution engine 57 could be configured to directly generate commands suitable for execution of the test procedure, including monitoring all feedbacks, calculating necessary intermediate values for execution, calculating values defined by the user, etc. and rendering all desired displays configured by the user, in a further embodiment, the execution engine 57 provides calls or commands to the system controller 23 to initiate and execute task modules operable on the system controller 23 for performing many of the activities, conditions, events and steps to execute the test procedure. Each task module operable on the system controller 23 is designed to operate independently in order to complete the activity, condition, event or step (but receiving inputs from other task modules if needed). The execution engine 57 may receive feedbacks from each of the task modules during operation, if necessary, for example, when the user has defined a variable(s) that will be displayed on the screen that comprises a calculation based on a feedback signal. (The user defines what variables are to be used and what signals are to be used where a mapped relationship is then retained and used by the execution engine 57. The workflow program such as Microsoft WorkFlow Foundation provides input access points, i.e., “hooks”, such as application program interfaces (APIs), that allow the execution engine 57 to render the desired data.) The execution engine 57 will also receive indications when each of the activities, conditions, events or steps have been completed based on the corresponding task modules running on the system controller 23. As appreciated by those skilled in the art, the execution engine 57 can also be configured to operate on the system controller 23, if desired.

In the exemplary embodiment of FIG. 5, when the Run button the test procedure data 55 is accessed by the execution engine 57 and initiates a corresponding “Run” task module 61 that is configured to generally oversee the test procedure, performing “Stops” or “Holds” as may be initiated by the user. The execution engine 57 will then initiate a “Parallel” task module 63 that is configured to control test machine 12 pursuant to the parallel operation defined in the test procedure data 55. The “Parallel” task module 63 will report back when the activities, conditions, events or steps have been completed in the parallel branches have been completed pursuant to the attributes and/or parameters of the parallel activity.

Many, but not necessarily all of the activities, conditions, events or steps in the parallel branches cause corresponding task modules to be initiated on the system controller 23 by the execution engine 57. Some In this case, a “Ramp” task module 65 and a “Data Acquisition” task module 67 are initiated. Although each of these task modules operate as individual modules in order to perform each of their respective tasks, each again is overseen by the “Parallel” task module 63 to which they pertain. The complete logic of the test procedure is implemented by the execution engine 57 by initiating corresponding task modules (in a hierarchy and with the same tasks modules being initiated for different reasons and operating under different attributes or parameters), when necessary, while receiving data for execution of the test procedure and/or display on monitor 45.

It should be noted task modules such as “Ramp” task module 65, “Data Acquisition” module 69 and other task modules corresponding to activities such as “Dwell”, “Cycle”, “Custom Waveform”, etc. are configured to operate and provide signals to the servo controller 14 in order to obtain suitable command signals, for instance, to control the actuator 15 as needed. Hence during operation of the test procedure, communication exists between the execution engine 57 and the task modules of system controller 23, while the task modules communicate with the servo controller 14. In addition, the execution engine 57 communicates with the workflow program run module 73 during operation of the test procedure in order to render data and start, hold and stop the test procedure when desired.

Although the present invention has been described with reference to preferred embodiments, workers skilled in the art will recognize that changes may be made in form and detail without departing from the spirit and scope of the invention. For instance, although the foregoing embodiments each included two separate supports on each side of the vehicle, this should not be considered limiting. In further embodiments one or more supports can be provided on each side of the vehicle. In addition, each support may connect to one or more points on the vehicle.

### APPENDIX

### Data Acquisition in Command Activities

### Variable Use in Multiple Data Acquisition Activities

Multiple data acquisition activities can be added in one composite data acquisition activity. For example, a timed activity and one or more peak-valley activities may occur in a composite activity. However, a variable can be computed in only one signal data calculation in a given data acquisition activity. When the application performs the activity, each signal variable is unique and receives a value from only one calculation.

### About Variable Mapping

Cycle, point-by-point, and group data acquisition activities require variables to be mapped to the signals.
Four types of data can be calculated for each signal that is selected for data acquisition. The data types are: Mean, Minimum, Maximum and Array.
If a variable is mapped to signal data, the data is calculated during the test run for those cycles that are selected or defined in the properties for the data acquisition activity. The data values for each acquired cycle are available for use in the runtime display and are saved for post-test analysis. Alternatively, a user-defined variable can be mapped to any signal data calculation.

### Cycle Properties

Cyclic data is stored at the end of each cycle. Group data is stored at each boundary, such as a step or segment. Noncyclic data is stored at the end of the data acquisition. For data acquisition, cycle selection is used to select the cycles to acquire for analysis.

### Cycles Per Decade (Logarithmic)

Specifies the increments at which cycles are shown or acquired per decade. Cycle counts are divided into logarithmic decades, which are in factors of 10 (for example 10, 100, 1000, and so on). The application divides the number of cycles in the decade by the number of Cycles per Decade to determine the increments at which it can reference the cycles in the decade. For example, if 10 is specified and the test is 105 cycles long, the total number of cycles would span into the third decade. In the first decade, the cycle increments are 1 (10/10=1), which equates to cycles 1, 2, 3, 4, 5, 6, 7, 8, 9, 10. In the second decade, the cycle increments are 10 (100/10=10), which equates to cycles 10, 20, 30, 40, 50, 60, 70, 80, 90, 100. In the third decade, the cycle increments are 100 (1000/10=100), which equates to cycle 100. The test is over before the next increment.

### Every nth Cycle (Linear)

Specifies the increments at which cycles are shown or acquired over the entire activity. For example, if 10 is specified and the test is 105 cycles long, cycles 10, 20, 30, 40, 50, 60, 70, 80, 90, or 100 could be shown or acquired.

### Designate Specific Cycles

Specifies a series of cycle numbers to show or acquire. Each cycle number must be separated by a space.

### Cycle Change Criteria Variable

Monitor a change in a selected variable, and then show or acquire cycle data when the variable deviates by more than the specified amount. One can select any one variable that is defined in the test. One can select any one variable that is defined in the test. After the variable is selected, its dimension appears and allows you to Specifies the amount of change. The amount of change can be specified with a numeric value for the shown dimension or with a variable.

### Change Criteria Threshold

Specifies the amount of deviation for the Cycle Change Criteria Variable. The amount of change can be specified with a numeric value for the shown dimension or with a variable.
Update Interval (For Displays only) Specifies the speed at which data can be shown. This is useful for high-speed tests that would otherwise require too much CPU capacity to show all data points with high-frequency cycles.
Buffer Size Specifies the total number of data points to monitor.

### About Point-by-Point Data Acquisition

Point-by-point data acquisition stores the value of each data point as part of an acquisition activity in a test run. The value becomes available to runtime, postprocessing, and analysis activities.
Starting Cycles Specifies how many cycles to acquire in the event the test starts or restarts. For example, you Specifies 10 and the test is 50 cycles long. The user stops and restarts the test at 30 cycles. The application saves data from cycles 0 to 10 and 30 to 40.
Final Cycles Specifies the number of cycles to acquire before the test stops, whether at the end or during the test. A stoppage can be initiated by a user, an event action, or a system interlock. For example, you Specifies 10 and the test is 50 cycles long. If the user stops and restarts the test at 30 cycles, the application saves data for cycles 0-10 and 30-40.
Index Variable Specifies an array variable to store all the cycle count numbers of cycles for which data is acquired for the activity during the test.

### Activities

### Cycle Activity

The Cycle activity commands the control signal to cycle between two different end levels at a specified frequency, using a specified wave shape, for a specified number of cycles. Two end levels form one cycle. The number of cycles determines the required number of end levels. The frequency determines the speed required to achieve the end levels. The method for cycling between the two end levels is controlled by the Control Mode, which can be specified in terms of Force, Strain, or Displacement. The end level specifies the amount of force or strain to apply or the distance to displace, while the Frequency specifies the speed it should take to achieve the end levels. The Wave Shape specifies the shape of the signal, which also governs the type of command rate between each end level, which can produce a constant linear rate (as with a ramp shape) or a varying rate (as with a sine shape). At the end of the number of cycles, the next activity in the procedure is runs.

### Cycle Activity Properties

Display Name Specifies a name to identify the activity in the procedure.
Wave Shape Specifies the shape of the signal. The shape determines whether the command rate between each end level is a constant linear rate (as with a ramp shape) or a varying rate (as with a sine shape). The choices are: Square, Ramp, Sine, True Square, True Ramp, True Sine.
Frequency Specifies the speed to complete each cycle.
Number of Cycles Specifies the number of end levels.
Compensators Specifies a compensator to improve the tracking and accuracy of the control loop for the selected channel.

### No Compensator

Static and Dynamic Null Pacing—Static null pacing holds the command at its segment boundaries, which allows the sensor feedback more time to reach its target peak. Dynamic null pacing reduces the command frequency, which allows the sensor feedback more time to track the command.
Peak-Valley Amplitude Control—Monitors cyclic command feedback for any amplitude rolloff or mean-level divergence. Peak-Valley Amplitude Control increases the command amplitude if it detects amplitude roll-off in the feedback signal. This compensator adjusts the mean command level if it detects mean-level divergence in the feedback signal.
Peak-Valley-Phase—Improves the amplitude and phase tracking of the command and sensor feedback. Peak-Valley-Phase compensates for phase error, unlike Peak-Valley Amplitude Control. Peak-Valley-Phase provides good amplitude tracking on nonlinear specimens. Peak-Valley-Phase adjusts the mean command level if it detects mean-level divergence in the feedback signal.
Control Mode Specifies the type of feedback to use in the control loop for the selected channel.
End Level 1 and 2 Specifies two end levels that the command signal cycles between for the selected control mode.
Phase Lag Specifies the phase relationship of the waveform generated by this activity from channel to channel.
Cycle with Data Acquisition Activity
The Cycle with Data Acquisition activity is two activities combined into one.
These activities are: Cycle activity Data Acquisition activity Cycle activity Use the Cycle activity to command the control signal to cycle between two different end levels at a specified frequency, using a specified wave shape, for a specified number of cycles. Two end levels form one cycle. The number of cycles determines the required number of end levels. The frequency determines the speed required to achieve the end levels.

### Data Acquisition Activity

Use a Data Acquisition activity to define the data to collect and how to collect it.

### Custom Waveform Activity

The Custom Waveform activity commands a control channel using a series of ramp and hold segments to make up a custom trapezoid waveform. Each ramp can have a different duration and end level, and each hold can have a different duration. The shape of the ramp segment is linear. The number of cycles determine how many times the entire custom waveform is generated.

### Custom Waveform Activity Properties

Display Name Specifies a unique name to identify the activity in the procedure.
Number of Cycles Specifies the number of times the custom waveform repeats.
Compensator Specifies a compensator to improve the tracking and accuracy of the control loop for the selected channel.

### Choices:

### No Compensator

Static and Dynamic Null Pacing—Static null pacing holds the command at its segment boundaries. As a result, the sensor feedback has more time to reach its target peak. Dynamic null pacing reduces the command frequency. As a result, the sensor feedback has more time to track the command.
Channel List Specifies the channel or multiple channels to which you want to use for the activity.
Control Mode Specifies the type of feedback to be used in the control loop for the selected channel.
Wave Shape Species Ramp or Hold as the waveform segment shape. Ramp segments are linear in shape.
Duration Ramp—Specifies the duration of time that the ramp takes to achieve its end level.
Hold—Specifies the duration of time that the segment holds at its current state.
End Level Specifies the end level for the ramp segment.
Custom Waveform with Data Acquisition Activity
The Custom Waveform with Data Acquisition activity combines two activities: Custom Waveform activity and Data Acquisition activity.
Custom Waveform activity
Use a Custom Waveform activity to command a control channel using a series of ramp and hold segments to generate a custom trapezoid waveform. Each ramp can have a different duration and end level, and each hold can have a different duration. The shape of the ramp segment is linear. The number of cycles determine how many times the application generates the custom waveform. One control mode is specified for the entire custom waveform.

### Data Acquisition Activity

Use a Data Acquisition activity to define the type of data to collect and how to collect it. You must add at least one data acquisition activity, and you can add multiple data acquisition activities. Each Data Acquisition activity must have a unique name, a trigger type, and a number of cycles to monitor.

### Dwell Activity

The Dwell activity commands the control signal to hold a level for a specified duration of time. The method for holding a level is controlled by the Control Mode. Settings include Force, Strain, or Displacement. At the start of the Dwell activity, the control signal is set to the current feedback level. The selected control mode maintains that level for the specified amount of time.

### Dwell Activity Properties

Display Name Specifies a name to identify the activity in the procedure.
Duration Specifies how long the level should hold at its current state.
Channel List Specifies the channel or multiple channels to which the dwell activity applied.
Control Mode Specifies the type of control mode for each channel.

### Ramp Activity

The Ramp activity commands the control signal from its current end-level state to a specified end level within a specified amount of time. The method used to obtain the End Level is determined by the Control Mode, which can be specified in terms of Force, Strain, or Displacement. The End Level specifies the amount of force or strain to apply or the distance to displace. The Duration specifies the amount of time that the ramp should take to achieve its End Level. The Ramp Shape specifies the signal shape, which governs the type of command rate within the time duration. The command rate can be constant (as with a ramp shape) or variable (as with a sine shape). At the end of the Duration, the next activity in the procedure runs.

### Ramp Activity Properties

Display Name Specifies a name to identify the activity in the procedure.
Ramp Shape Specifies a shape for the ramp command signal. The shape determines the rate at which the end level command is applied during the time duration. The ramp shape choices are: Square, Ramp, Sine, True Square, True Ramp, True Sine.
Duration Specifies the duration of time that the ramp should take to achieve its end level.
Compensator Specifies a compensator to improve the tracking and accuracy of the control loop for the selected channel. The choices are

### No Compensator

Static and Dynamic Null Pacing—Static null pacing holds the command at its segment boundaries. As a result, the sensor feedback has more time to reach its target peak. Dynamic null pacing reduces the command frequency. As a result, the sensor feedback has more time to track the command.
Channel List Specifies the channel or multiple channels to use for the activity.
Control Mode Specifies the type of feedback to use in the control loop for the selected channel.
End Level Specifies the end level for the control mode.

### Data Acquisition Activity

The Data Acquisition activity accumulates data for selected signals. The activity requires at least one trigger and one signal. The Trigger defines the method for acquiring data points. The Buffer Size defines the total number of data points to acquire. In a procedure, a Data Acquisition activity is typically a Parallel Path activity in conjunction with one of the commands activities.

### Data Acquisition Activity Properties

Display Name Specifies a name for the activity to display in the Test Editor.
Buffer Size Specifies the total number of data points to monitor. This property can be specified with a numeric value and unit of measure or with a variable. Trigger List
Signal List Specifies the signals to be processed in the data acquisition activities.

### Data Acquisition Trigger Properties

Trigger Type Specifies a trigger type to determine how to collect data for specific signal(s). Choices include Timed, Delta Level, Peak-Valley and Minimum-Maximum.
Timed data acquisition records the values of selected signals at a user-set Frequency (sample rate).
Delta Level acquires data in selected signals when the reference signal changes by a certain amount.
Peak-Valley data acquisition records the values of selected signals when the application detects a peak or valley in the reference signal specified. The noise band defines how much the signal must change before the application detects a peak or valley data point. Signal changes that are less than the noise band are not acquired.
Minimum-Maximum data acquisition monitors selected signals along with the reference signal. The reference signal is monitored for the smallest value and largest value. The noise band defines how much the signal must change before the application detects a minimum or maximum data point. Values are replaced when exceeded.

### Cycle Change Detection Activity

The Cycle Change Detection activity defines when a variable calculation for a reference cycle changes by more than the specified difference allowed. The cycle information that causes the change is stored in a result cycle variable. The next activity in the test procedure cannot occur until the change detector is triggered.

### Cycle Change Detection Activity Properties

Display Name Specifies a name to identify the activity in the procedure.
Difference Allowed Specifies a variable that specifies the amount of difference allowed between the Reference Value and Formula. When the difference allowed is exceeded, the cycle count number is recorded in the Result Cycle variable.
Reference Cycle Specifies the cycle at which the comparison begins. This property can be set by typing a number or by referencing a variable.
Reference Value Specifies a variable to compare to the Formula variable.
Formula Specifies a variable to compare to the Reference Value variable.
Result Cycle Specifies a variable to use to store the cycle information that caused the change. The list shows only variables that have a dimension of “count.”

### Digital Input Activity

The Digital Input activity can be set to monitor and respond to digital input signal condition states—signal too high or low; or transition from low to high or high to low. The activity can be set to cause an action if one signal reaches its defined state.

### Digital Input Activity Properties

Display Name Specifies a unique name to identify the activity in the procedure.
Monitor Sets the type of monitoring for the activity: One Time—One check of the inputs is performed. The action is triggered only if the conditions are detected by the one-time check. Continuous—A continuous check of the inputs is performed. The action is triggered if any of the checks detects that the conditions are met.
Trigger When Sets the trigger conditions. Any Digital Event Occurs—Any one of the monitored events can trigger the action if the signal conditions are met. All Digital Events Occur—All monitored signals must reach their signal conditions for the activity trigger to occur.
Action Specifies the action to take: None—No action occurs. Indicate—A message is generated and shown to the operator Station Power Off—The station power is turned off. All testing is terminated. Interlock—An interlock is generated. Program Stop Interlock —The program stops and an interlock is generated. Program Hold Interlock—The program holds and an interlock is generated. Program Hold—The program holds. Program Stop—The program stops.
Digital Input List Specifies the specific digital inputs to be monitored by the activity. Each digital input can be monitored for a specific state. None—The signal is not monitored. Low to High—The digital signal changes from low to high. High to Low—The digital signal changes from high to low. Either—The digital signal changes from low to high, or from high to low. Channel High—The digital signal is too high. Channel Low—The digital signal is too low.

### Limit Detection Activity

The Limit Detection activity monitors signals and variables during a test run and compare their values against defined upper and lower limits. Configure the Limit Detection activity to respond to a single limit event or multiple limit events.

### Limit Detection Activity Properties

Display Name Specifies a unique name to identify the activity in the procedure.
Settings>Completion Select Any Limit to cause the Limit Detection to trigger based on any single monitored item reaching its limit. Select All Limits to cause the Limit Detection to trigger only if all monitored items reach their limits.
Settings>Log Select whether the limit event is logged as Informational, Warning, or Error.
Signal Limits Select signals that are to be monitored.
Variable Limits Select variables that are to be monitored.
Variable Limits>Comparison Mode Select Absolute to set a defined value for a limit. Select Relative to set the limit relative to the value when the activity starts.
Lower Limit>Action Specifies the action to take if the lower limit conditions are met: Disabled—Disables the limit. Indicate—A limit indication is generated and shown to the operator. Program Hold—The program holds. Program Stop Interlock—The program stops and an interlock is generated. Program Stop—The program stops. Program Hold Interlock—The program holds and an interlock is generated. Interlock—An interlock is generated. Station Power Off—The station power is turned off. All testing is terminated.
Lower Limit>Value Specifies the value to trigger a limit event. If the monitored values fall below this value, a limit event occurs.
Upper Limit>Action Specifies the action to take if the upper limit conditions are met: Disabled—Disables the limit. Indicate—A limit indication is generated and shown to the operator. Program Hold—The program holds. Program Stop Interlock—The program stops and an interlock is generated. Program Stop—The program stops. Program Hold Interlock—The program holds and an interlock is generated. Interlock—An interlock is generated. Station Power Off—The station power is turned off. All testing is terminated.
Upper Limit>Value Specifies the value to trigger a limit event. If the monitored values exceeds this value, a limit event occurs.

### Stable Cycle Detection Activity

The Stable Cycle Detection activity defines the parameters for the stable cycle of a test. The stable cycle is determined by comparing the relative values of two variables. When the comparison between the values is consistent within a defined percentage for a defined number of cycles, a stable cycle is achieved. The cycle number at which the stability is achieved is stored in a result cycle variable. The next activity in the procedure cannot occur until the stable cycle is established.

### Stable Cycle Detection Activity Properties

Display Name Specifies a unique name to identify the activity in the procedure.
Percent Change Specifies the percentage of change allowable between the Formula min and Formula max. This property can be set by typing a number or by referencing a variable.
Number of Cycles Specifies the number of consecutive cycles that the Percent Change must be within its parameter in order for the command cycles to be considered “stable.” This property can be set by typing a number or by referencing a variable.
Formula minimum and maximum Specifies the values to be compared. When the comparison between the values is within the Percent Change for the Number of Cycles, a stable cycle is achieved.

### State Change Detection Activity

The State Change Detection activity checks for a specific program state. The activity typically occurs in parallel with other activities to limit them or provide a path if an activity fails. For example, a parallel path contains a State Change Detection activity that monitors for a stop condition. If the test stops, the UserStop variable is set to True.

### State Change Detection Properties

Display Name Specifies a name to identify the detection event.
Running The procedure is controlling the machine and playing out a waveform.
Stopped The procedure and controller actuators are fully stopped.
Hold The state in which the test procedure suspends the activity on the controller. The actuator is not moving, but the test can be continued by clicking the Run button.
Starting The transition state between Stopped and Running.
Stopping The transition state between Running or Holding and Stopped.
Holding The transition state between Running and Holding.
Resuming The transition state between Hold and Running.

### Wait for Event Activity

The Wait for Event activity is used to indicate when the test flow should wait for a condition to be true. The Wait for Event is a blocking activity that ends when the condition is met, allowing activities below it to execute. To prompt a user to provide a simple value, use the Input Parameters activity. To evaluate existing calculations, use the Calculate Variables selection.

### Wait for Event Properties

Display Name Specifies a name to identify the event procedure.
Condition Specifies the event condition.

### Auto Offset Activity

Use the Auto Offset activity to apply an automatic offset for a group of selected feedback signals.
Feedback offset Feedback offset alters the feedback signal used by the controller to zero the conditioner output.

### Auto Offset Activity Properties

Display Name Specifies a unique name to identify the activity in the procedure.
Signal List Specifies the signals to be processed in the Auto Offset activity.

### Reset Cycle Count Activity

The Reset Cycle Count activity resets the cycle counter for the selected channel to zero while the test is in process. At the start of a test, the cycle count is zero. The Reset Cycle Count activity allows one to force the cycle count to zero later in the test procedure.

### Reset Cycle Count Properties

Display Name Specifies a unique name to identify the activity in the procedure.
Channel Specifies the channel that has its cycle count set to zero when this activity occurs in the test procedure.

### Set Calculation Parameter Activity

The Set Calculation Parameter activity changes the value of a controller calculation parameter. This activity provides support for calculated signal and output processing. Physical characteristics are to change at the controller test level, for example, a force signal could change at a particular temperature.

### Set Calculation Parameter Activity Properties

Display Name Specifies a name to identify the change variable as seen in the user interface. This name can contain alphanumeric and all other characters.
Parameter The content is dependent on the variable definition.
Set Value Specifies the value

### Set Control Event Activity

Use the Set Control Event activity to trigger an action in the controller and optionally log a message based on test conditions or on user input. The list of actions is controller-dependent. This activity is typically used in conjunction with an If-Else Condition activity that evaluates a test condition or variable that contains user input. For example, the activity shuts down the test, triggers an action supported by the controller, or writes a message to the log. This activity is used in conjunction with the State Change Detection activity to determine if the change has occurred before continuing with subsequent activities. For example, the Set Control Event activity can trigger a Program Hold action

### Set Control Event Activity Properties

Display Name Specifies a name to identify the activity in the procedure.
Action Specifies the action to be performed by the activity. The list of actions is controller-dependent. Typical actions include: None—No resulting action occurs. Message Only—A message is displayed for the user and is optionally recorded in the log, but no other action occurs. Program Hold—The program holds. Program Stop Interlock—The program stops and an interlock is generated. Program Stop—The program stops. Program Hold Interlock—The program holds and an interlock is generated. Interlock—An interlock is generated. Station Power Off—The station power is turned off. All testing is terminated.
Log as Specifies if the activity should be logged and whether it is Diagnostic, Information, Warning, Error, or Fatal.
Message Create a message to be displayed to the operator and optionally recorded in the log.

### Set Digital Output Activity

The Set Digital Output activity sets the state of a selected digital output signal to either On or Off. The state of the digital output is set when the activity is encountered in the test procedure and remains at that state unless it is changed by a different occurrence of the Set Digital Output activity.

### Set Digital Output Activity Properties

Display Name Specifies a unique name to identify the activity in the procedure.
Digital Signal Specifies the signal.
Value Specifies the required state for the digital output.

### Set Span and Setpoint Activity

The Set Span and Setpoint activity sets new values to the span and setpoint properties of a channel in the controller. Span is a multiplier adjustment on the command waveform; setpoint is an offset adjustment on the command waveform. Use this to control the amplitude of the command waveform based on a calculation or an operator input.
One Time Monitor One time activity immediately set the specified setpoint and span in to the controller and then closes. Use this to set an initial value or place within a While loop along with the calculation that generates the values to send to the controller.
Continuous Monitor Continuous activity monitors specified variables for span and setpoint values and sets them in the controller whenever the variable values change. The activity runs until the parallel activity in which it is contained is closed from another branch.

### Set Span and Setpoint Properties

Display Name Specifies a name to identify the activity in the procedure.
Monitor Specifies if this activity pushes the set point and span into the controller one time or on a continuous basis.
Channel Specifies the channel to use for the activity.
Control Mode Specifies the controller-specific mode for control feedback to use in the channel control loop. Each control mode has its own setpoint. However, all the control modes on a channel have their spans connected together.
Span Specifies the scalar multiplier that is applied to a command channel by the controller.
Setpoint Specifies the offset applied to a command channel by the controller.

### If-Else Condition Activity

The If-Else Condition activity creates two possible paths for a test procedure based on a conditional expression that evaluates to True or False. If the expression evaluates to True, the test procedure follows the “If” path. If the expression evaluates to False, the test procedure follows the “Else” path. The evaluated condition can be the result of a response from the operator, or it can be an evaluation of a specific test value or condition.
The two possible paths for the procedure to follow are automatically created when the If-Else Condition activity is added to the test procedure. Each path can contain zero or more activities, including additional If-Then Condition and other activities.

### If-Else Condition Activity Properties

Display Name Specifies a name to identify the activity in the procedure. Each individual branch also has a Display Name property.
Condition Specifies the condition which must evaluate to True or False. Variables, operators and functions can be used.

### Parallel Path Activity

The Parallel Path activity enables you to use alternate and parallel paths within a test procedure. Each parallel path can contain a series of activities that run sequentially within that path. The activities in the path run simultaneously and independently of activities in the other parallel paths.

### Parallel Path Activity Properties

Display Name Specifies a name to identify the activity in the procedure. Each parallel path has a Display Name property.
Context Edit—Note using the graphical user interface the parallel paths can be managed including: Move Left—Shifts the selected path to the left. Move Right—Shifts the selected path to the right. Add Branch—Adds a new, empty path to the activity. Cut—Delete the parallel path or an activity and save it to the clipboard.
Copy—Copy the parallel path or activity. Paste—Paste the parallel path or activity.
Delete—Delete the selected path and its contents. Properties—Open the Parallel Path activity properties screen.

### While Loop Activity

The While Loop activity repeatedly runs the activities defined within it as long as a defined condition evaluates to True. If the defined condition is False at the start or at the repeat of the loop, the While Loop activity does not run. The tested condition can be the result of a response from the operator or an evaluation of a specific value or condition.

### While Loop Activity Properties

Display Name Specifies a name to identify the activity in the procedure. The internal path of the While Loop activity has its own Display Name property.
Condition Specifies the condition which must evaluate to True or False. Variables, operators and functions can be used.

### Custom Message Window Activity

The Custom Message Window activity displays messages to the operator and records the operator's response.

### Custom Message Window Activity Properties

Display Name Specifies a unique name to identify the activity in the procedure.
Create Message Specifies the message.
Window Size>Width Specifies the width of the message window in pixels.
Window Size>Height Specifies the height of the message window in pixels.
Buttons Specifies if the types of buttons, if any, such as No Buttons, Yes, No, OK, Cancel.
Button Alignment Specifies how the buttons are aligned.
Results Variable Specifies a variable to present

### Input Parameters Activity

Use the Input Parameters activity to assign values to one or more variables. When the activity runs, a list of selected variables and their current values is shown. You can edit the variable values as required. The Input Parameters activity accepts simple values only. Calculations or references to other variables are not evaluated.

### Input Parameters Activity Properties

Display Name Specifies a name to identify the activity in the procedure.
Message Specifies a message or prompt for the operator.
Variable List Specifies which variables for which operator input is requested.

### Assign Variables Activity

Use the Assign Variables activity to explicitly calculate and assign values to one or more variables in the test. One can also add a calculation that uses a variable with a choice list for activities such as If-Else or While loops. For each variable, a calculation to set the value of the variable must be provided. The calculation can be a simple value, a reference to another variable, or a calculated value that can reference other variables. Prompting the user for input can also be performed.

### Assign Variables Activity Properties

Display Name Specifies a unique name to identify the activity in the procedure.
Variable List Lists the name, value and units of variables that are calculated in the activity.

### Calculate Variables Activity

The Calculate Variables activity calculates all variables assigned to the activity to their current values.

### Calculate Variables Activity Properties

Display Name Specifies a name to identify the activity in the procedure.
Variable List Specifies variables

### Run Report Activity

The Run Report activity generates a test report based on an assigned report layout.

### Run Report Activity Properties

Display Name Specifies a name to identify the activity in the procedure.
Report Layout Displays the currently assigned report layout for the activity.

### Log Message Activity

The Log Message activity writes an entry to the message log when a test performs the activity. The entry can contain text and the value of one or more single-value variables.

### Wait Activity

Use the Wait activity to pause the test procedure for a specified amount of time. You can use the Wait activity in the following ways: With a Variable—Input a wait time when prompted at the beginning of the test. When the test procedure reaches the Wait activity, the test uses the variable that was set up in the Input activity and pauses for the specified time. With a Literal Value—Specifies a amount of time for the Wait activity so that when the procedure reaches the Wait activity, the test waits for the specified amount of time that was set up through the Wait activity properties window. As a controlling Activity—Place the Wait activity in a parallel path as the controlling activity. Any activities below the Wait activity in that path wait, but the activities in the parallel path continue to run. If you stop the procedure, the Wait activity also stops. When you restart the procedure, the Wait activity resumes, but only for the remainder of the time that was specified for the Wait activity.

### Wait Activity Properties

Display Name Specifies a name to identify the Wait activity in the procedure.
Duration Specifies how long the you want the wait period to last.

What is claimed is:

1. A testing machine system configured to apply tests to a test specimen and obtain measurement therefrom, the testing machine system comprising:
at least one computer, the computer having a graphical user interface;
a test procedure generator configured to operate on said at least one computer, the test procedure generator including a workflow program configured to receive user input using the graphical user interface and create a test procedure represented by connected graphical icons, wherein the test procedure generator is configured to output a textual output readable by a human representing the test procedure;
a test machine having a controllable element configured to apply a test to a test specimen; and
a system controller configured to operate on said at least one computer, the system controller configured to receive the data related to the textual output and control the controllable element as defined by the test procedure.

2. The testing machine system of claim 1 wherein the system controller comprises a plurality of modules, wherein each of the modules correspond to an element of the test procedure, the test machine further comprising an execution engine module configured to operate on said at least one computer, the execution engine configured to receive the textual output and provide a command to initiate a selected module based on a portion of the textual output.

3. The testing machine system of claim 2, wherein a first module of the plurality of modules is configured to execute test procedure control flow among a plurality of control flow branches.

4. The testing machine system of claim 3 wherein a second module of the plurality of modules is configured to control the controllable element.

5. The testing machine system of claim 4 wherein the second module is part of one of the flow control branches.

6. The testing machine system of claim 5 wherein the execution engine module is configured to receive data indicative of tests performed on the test specimen from at least some of the plurality of modules and provide said data to the workflow program for rendering to the user via the graphical user interface.

7. The testing machine system of claim 6 wherein the execution engine module is configured to calculate values based on received data indicative of tests performed on the test specimen from at least some of the plurality of modules.

8. The testing machine system of claim 6 wherein the textual output comprises a markup language.

9. The testing machine system of claim 8 wherein the markup language comprises XML.

10. The testing machine system of claim 6 wherein the test machine comprises an actuator assembly.

11. The testing machine system of claim 10 wherein the test machine comprises at least one actuator and a servo controller configured to control the actuator, and wherein the system controller is operably coupled to the servo controller to provide inputs to the actuator based on operation of the second module.

12. The testing machine system of claim 2 wherein the plurality of modules are configured to operate in a hierarchy.

13. A testing machine system configured to apply tests to a test specimen and obtain measurement therefrom, the testing machine system comprising:
at least one computer, the computer having a graphical user interface;
a test procedure generator configured to operate on said at least one computer, the test procedure generator including a workflow program configured to receive user input using the graphical user interface and create a test procedure represented by connected graphical icons, wherein the test procedure generator is configured to output a textual output readable by a human representing the test procedure;
a test machine comprising an actuator assembly configured to apply a load to or displace the test specimen; and
an execution engine module configured to operate on said at least one computer, the execution engine configured to receive the textual output and provide a command for use as a basis to control the actuator assembly as defined by the test procedure.

14. The testing machine system of claim 13 wherein the execution engine module is configured to receive data indicative of tests performed on the test specimen and provide said data to the workflow program for rendering to the user via the graphical user interface.

15. The testing machine system of claim 14 wherein the execution engine module is configured to calculate values based on received data indicative of tests performed on the test specimen from at least some of the plurality of modules.

16. The testing machine system of claim 13 and further comprising a plurality of modules, wherein each of the modules correspond to an element of the test procedure, wherein the execution engine module is configured to operate on said at least one computer, the execution engine configured to receive the textual output and provide a command to initiate a selected module based on a portion of the textual output.

17. The testing machine system of claim 16, wherein a first module of the plurality of modules is configured to execute test procedure control flow among a plurality of control flow branches.

18. The testing machine system of claim 17 wherein a second module of the plurality of modules is configured to control the controllable element.

19. The testing machine system of claim 18 wherein the second module is part of one of the flow control branches.

20. The testing machine system of claim 19 wherein the execution engine module is configured to receive data indicative of tests performed on the test specimen from at least some of the plurality of modules and provide said data to the workflow program for rendering to the user via the graphical user interface.

21. The testing machine system of claim 20 wherein the execution engine module is configured to calculate values based on received data indicative of tests performed on the test specimen from at least some of the plurality of modules.

22. The testing machine system of claim 21 wherein the plurality of modules are configured to operate in a hierarchy.

23. A computer implemented method for controlling a test machine pursuant to a test procedure, the test machine having a plurality of modules, wherein each of the modules correspond to an element of the test procedure, the method comprising:
operating a workflow program on a computer with a graphical user interface to configure a test procedure using connected graphical icons representative of elements of the test procedure;
operating the workflow program to generate a textual output data in a form readable by a human representing the test procedure; and
accessing the textual output data to initiate a selected module of the plurality of modules based on a portion of the textual output, the module configured to control a controllable element operably coupled to a test specimen.

24. The computer implemented method of claim 23 wherein the textual output comprises test elements arranged in a hierarchical manner and wherein accessing includes initiating modules of the plurality of modules in a hierarchical manner.

25. The computer implemented method of claim 24 and further comprising receiving data indicative of tests performed on the test specimen from at least some of the plurality of modules and providing said data to the workflow program for rendering to the user via the graphical user interface.

26. The computer implemented method of claim 25 and further comprising calculating values based on received data indicative of tests performed on the test specimen from at least some of the plurality of modules.

27. A testing machine system configured to apply tests to a test specimen and obtain measurement therefrom, the testing machine system comprising:
at least one computer, the computer having a graphical user interface;
a test machine having a controllable element configured to apply a test to a test specimen; and
a test procedure generator configured to operate on said at least one computer, the test procedure generator including a workflow program configured to receive user input using the graphical user interface and create a test procedure represented by connected graphical icons representing corresponding activities for controlling the controllable element.

28. The testing machine of claim 27 wherein the test procedure includes a parallel path, and wherein in one of the graphical icons represents a parallel path having two branches and wherein a first activity comprises a first branch and a second activity comprises a second branch.

29. The testing machine of claim 28 wherein the first activity comprises controlling the controllable element and the second activity comprises data acquisition.

30. The testing machine of claim 27 wherein in one of the graphical icons represents a loop and wherein an activity is located in the loop.

31. The testing machine of claim 27 wherein the test procedure includes a condition involving two paths, and wherein in one of the graphical icons represents the condition having two branches and wherein a first activity comprises a first branch and a second activity comprises a second branch.

32. A computer implemented method for controlling a test machine pursuant to a test procedure, the method comprising:
operating a workflow program on a computer with a graphical user interface to configure a test procedure using connected graphical icons representative of activities of the test procedure; and
obtaining an output from the workflow program and using the output to control the test machine pursuant to the arranged graphical icons.
